(19) United States
(12) Patent Application Publication
(10) Pub. No.: US 2025/0365773 A1
(43) Pub. Date: Nov. 27, 2025

(54) TEMPORARY IDENTIFIERS AND SECURITY FOR RANDOM ACCESS PROCEDURES

(71) Applicant: Lenovo (United States) Inc., Morrisville, NC (US)

(72) Inventors: Prateek Basu Mallick, Dreieich (DE); Joachim Löhr, Wiesbaden (DE); Shwetha Sreejith, Hessen (DE)

(21) Appl. No.: 19/288,499

(22) Filed: Aug. 1, 2025

(51) Int. Cl. H04W 74/0833; H04W 72/231; H04W 74/04

(52) U.S. Cl. CPC H04W 74/0833; H04W 72/231; H04W 74/04

(57) ABSTRACT

Various aspects of the present disclosure relate to methods, apparatuses, and devices for wireless communication. A user equipment (UE) may be configured to transmit a first random access transmission to a base station. The UE may be further configured to receive, in response, a second random access transmission comprising a first temporary identifier, perform a first security procedure using the first temporary identifier for scheduling, and receive a radio resource control (RRC) reconfiguration message that initiates a second security procedure. The RRC reconfiguration message includes a second temporary identifier. These techniques may enhance the protection of temporary identifiers during random access and security transitions.

### TECHNICAL FIELD

The present disclosure relates to wireless communications, and more specifically to temporary identifiers (IDs) and security for random access procedures in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, including in the claims, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved network entities, processors, and methods for using temporary IDs and security for random access procedures in a wireless communications system.

A UE for wireless communication is described. The UE may be configured to, capable of, or operable to transmit a first random access transmission to a base station, receive a second random access transmission comprising a first temporary ID in response, perform a first security procedure using the first temporary ID for scheduling, and receive a RRC reconfiguration message that initiates a second security procedure. The RRC reconfiguration message may include a second temporary ID, which may be used by the UE for monitoring downlink control information, receiving uplink grants, or transmitting uplink feedback based on an uplink feedback configuration associated with the second temporary ID.

A processor (e.g., a standalone chipset or a component of a UE) for wireless communication is described. The processor may be configured to, capable of, or operable to transmit a first random access transmission to a base station, receive a second random access transmission comprising a first temporary ID, perform a first security procedure with the base station using the first temporary ID, and receive an RRC reconfiguration message comprising a second temporary ID, wherein the RRC reconfiguration initiates a second security procedure. The processor may further monitor scheduling grants or feedback signaling based on the second temporary ID.

A method performed or performable by a UE for wireless communication is described. The method may include transmitting a first random access transmission to a base station, receiving a second random access transmission comprising a first temporary ID, performing a first security procedure using the first temporary ID for scheduling, and receiving a RRC reconfiguration message that includes a second temporary ID and initiates a second security procedure. The method may further include using the second temporary ID to receive uplink scheduling, transmit uplink feedback, and confirm application of the identifier through configured control signaling.

A base station for wireless communication is described. The base station may be configured to, capable of, or operable to receive a first random access transmission from a UE, transmit a second random access transmission comprising a first temporary ID in response, initiate a first security procedure with the UE wherein the first temporary ID is used for uplink or downlink scheduling, and transmit a RRC reconfiguration message that includes a second temporary ID and initiates a second security procedure. The base station may further determine, based on uplink feedback or scheduling behavior, whether the UE has applied the second temporary ID.

A processor (e.g., a standalone chipset or a component of a base station) for wireless communication is described. The processor may be configured to, capable of, or operable to receive a first random access transmission from a UE, transmit a second random access transmission comprising a first temporary ID, initiate a first security procedure using the first temporary ID for scheduling, and transmit a RRC reconfiguration message comprising a second temporary ID to initiate a second security procedure. The processor may be further configured to schedule transmissions, determine identifier transition, or configure control resources associated with the second temporary ID.

A method performed or performable by a base station for wireless communication is described. The method may include receiving a first random access transmission from a UE, transmitting a second random access transmission comprising a first temporary ID, initiating a first security procedure with the UE using the first temporary ID for scheduling, and transmitting a RRC reconfiguration message comprising a second temporary ID that initiates a second security procedure. The method may further include providing uplink or downlink scheduling based on the second temporary ID, receiving uplink feedback to confirm UE application of the identifier, or initiating timer-based procedures related to identifier transition.

### BRIEF DESCRIPTION OF THE DRAWINGS

FIG. 1 illustrates an example of a wireless communications system in accordance with aspects of the present disclosure.

FIG. 2 illustrates an example of a contention-based random access (CBRA) procedure using a four-step random access (RA) type in accordance with aspects of the present disclosure.

FIG. 3 illustrates an example of a CBRA procedure using a two-step RA type in accordance with aspects of the present disclosure.

FIG. 4 illustrates an example of a contention-free random access (CFRA) procedure using a four-step RA type in accordance with aspects of the present disclosure.

FIG. 5 illustrates an example of a CFRA procedure using a two-step RA type.

FIG. 6 illustrates an example of a CFRA procedure using a four-step RA type without monitoring for a network response in accordance with aspects of the present disclosure.

FIG. 7 illustrates additional aspects of random access procedures, including fallback and contention resolution in accordance with aspects of the present disclosure.

FIG. 8 illustrates an example of a fallback procedure for CBRA using a two-step RA type in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a NE in accordance with aspects of the present disclosure.

FIG. 12 illustrates a flowchart of a method performed by a network element in accordance with aspects of the present disclosure.

FIG. 13 illustrates a flowchart of a method performed by a user equipment in accordance with aspects of the present disclosure.

### DETAILED DESCRIPTION

Some wireless communication systems, including those involving one or more UEs, base stations, or other network entities, may support the use of temporary identifiers (IDs) during connection establishment procedures such as random access. These temporary IDs, such as a temporary mobile subscriber identity (TMSI) or a cell radio network temporary identifier (C-RNTI), may be allocated by the network to conceal permanent UE identifiers and facilitate scheduling or mobility. Although such temporary IDs may be refreshed periodically, there are instances in which they are transmitted in plaintext, potentially allowing an attacker to intercept and exploit them. This may lead to security vulnerabilities such as denial-of-service (DoS) attacks or unauthorized UE tracking through location correlation or signaling analysis.

Various aspects of the present disclosure relate to enhancing temporary ID protection in wireless communication systems. For example, one or more UEs and base stations may support a procedure to switch from a first temporary ID to a second temporary ID without performing a full handover, which may otherwise be complex, time-consuming, and power-intensive. In some implementations, a base station may receive a random access transmission from a UE, transmit a response including a first temporary ID, initiate a security setup procedure, and transmit control signaling comprising a second temporary ID. By supporting such transitions through a lightweight radio resource control (RRC) procedure, the system may reduce signaling exposure, improve UE privacy, and enhance security posture against interception or correlation attacks-without incurring the overhead of conventional mobility management procedures.

Aspects of the present disclosure are described in the context of a wireless communications system.

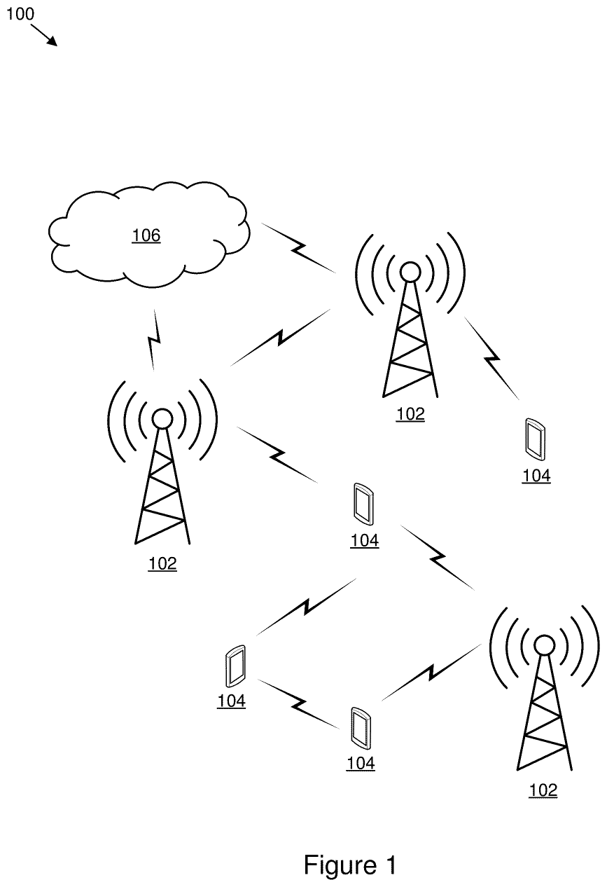

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, N6 or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

Security concerns may intensify with each successive generation of wireless technology. As a result, protecting UE identifiers (IDs) may become increasingly important in network implementations.

Although permanent UE IDs are typically well protected, the network may allocate temporary IDs, such as a temporary mobile subscriber ID (S-TMSI) or a C-RNTI. These temporary IDs may be refreshed periodically; however, in some instances, they may be transmitted in plaintext. When exposed in this manner, a malicious actor may be able to intercept the temporary ID and use it to launch a denial-of-service (DOS) attack or determine the UE's location, thereby enabling unauthorized tracking.

Privacy-sensitive fields carried in medium access control (MAC) control elements (CEs) may pose security vulnerabilities. The combination of different fields may lead to a series of problems, including tampering and location privacy leakage. When combined with intercepted temporary UE IDs, such vulnerabilities may allow an attacker to compromise user privacy and disrupt network integrity.

In some implementations, the systems and techniques disclosed herein may enable the network and the UE 104 to change a temporary ID without triggering a full handover procedure, which may otherwise be complex, time-intensive, and power-consuming. By using a new RRC signaling procedure, the network and the UE may transition to a new temporary UE ID in a secure and efficient manner.

A C-RNTI may be assigned to a UE 104 following completion of a random access procedure, derived from a temporary C-RNTI transmitted in a RAN Msg2. One example of a random access procedure is described herein. Although certain embodiments herein focus on using a C-RNTI, the described techniques may be similarly applied to other temporary UE IDs, such as international mobile subscriber identity (IMSI), international mobile equipment identity (IMEI), globally unique temporary UE identity (GUTI), temporary mobile subscriber identity (TMSI), gNB radio network temporary identifier (G-RNTI), temporary GUTI (T-GUTI), short UE flow identifier (SUFI), random access RNTI (RA-RNTI), system information RNTI (SI-RNTI), and paging RNTI (P-RNTI), to achieve equivalent protections.

A random access procedure may be triggered by a variety of events, including initial access from RRC_IDLE; an RRC connection re-establishment procedure; downlink (DL) or uplink (UL) data arrival during RRC_CONNECTED or RRC_INACTIVE while a small data transmission (SDT) procedure is ongoing and uplink synchronization is non-synchronized; UL data arrival when no physical uplink control channel (PUCCH) resources for scheduling request (SR) are available; handover, except when random access channel (RACH)-less handover (HO) is configured; SR failure; an explicit request by the RRC upon synchronous reconfiguration; an RRC connection resume procedure from RRC_INACTIVE; a need to establish time alignment for a primary or secondary timing advance group (TAG); a request for other system information (SI); a beam failure recovery; consistent UL listen-before-talk (LBT) failure on a serving primary cell (SpCell); SDT in RRC_INACTIVE; positioning during RRC_CONNECTED requiring a random access procedure (e.g., when timing advance is needed for UE positioning); early uplink synchronization with a long-term measurement (LTM) candidate cell; and RACH-based LTM cell switching.

Two types of random access (RA) procedures may be used: a four-step RA type that includes msg1, and a two-step RA type that includes msgA. Each RA type may support both contention-based random access (CBRA) and contention-free random access (CFRA).

The UE 104 may select the RA type at the initiation of the procedure based on network configuration. For example, when CFRA resources are not configured, the UE 104 may use a reference signal received power (RSRP) threshold to select between the two-step RA type and the four-step RA type. When CFRA resources are configured for the four-step RA type, the UE 104 may initiate random access using the four-step RA type. Similarly, when CFRA resources are configured for the two-step RA type, the UE 104 may initiate random access using the two-step RA type.

In some implementations, the network may not configure CFRA resources for both two-step and four-step RA types simultaneously within a given bandwidth part (BWP). Additionally, CFRA using the two-step RA type may be supported only in connection with a HO.

In the four-step RA type, msg1 may include a preamble transmitted on the physical random access channel (PRACH). Following msg1 transmission, the UE 104 may monitor for a response from the network within a configured response window. For CFRA, a dedicated preamble for msg1 may be assigned by the network, and upon receiving a random access response (RAR), the UE 104 may consider the procedure complete. For CBRA, upon receiving the RAR, the UE 104 may transmit msg3 using the UL grant included in the response and monitor for contention resolution. If contention resolution is not successful following msg3 transmission or retransmission, the UE 104 may return to the msg1 transmission stage.

The msgA of the two-step RA type may include a preamble transmitted on PRACH and a payload transmitted on PUSCH. After msgA transmission, the UE 104 may monitor for a response from the network within a configured response window. For CFRA, a dedicated preamble and PUSCH resource may be configured for msgA transmission, and upon receiving the network response, the UE 104 may consider the random access procedure complete. For CBRA, if contention resolution is successful upon receiving the network response, the UE 104 may also consider the procedure complete. However, if a fallback indication is received in msgB, the UE 104 may proceed to transmit msg3 using the UL grant included in the fallback indication and monitor for contention resolution. If contention resolution is not successful following msg3 transmission or retransmission, the UE 104 may return to the msgA transmission stage.

If the random access procedure using the two-step RA type is not successfully completed after a configured number of msgA transmissions, the UE 104 may be configured to switch to CBRA using the four-step RA type.

For a random access procedure toward an LTM candidate cell to acquire early UL TA, CFRA may be triggered by a PDCCH order. In this case, the UE 104 may transmit msg1 toward the candidate cell without monitoring for a response. To support UL power ramping, the UE 104 may retransmit msg1 as indicated by the network.

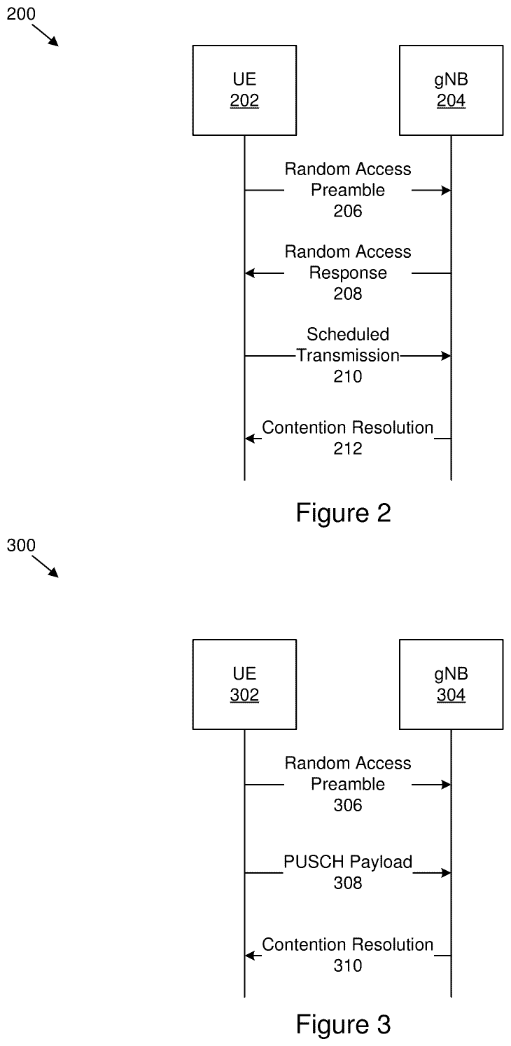

FIG. 2 illustrates an example of a CBRA procedure 200 using a four-step RA type in accordance with aspects of the present disclosure. As shown, a UE 202 may transmit a random access preamble 206 to a gNB 204. In response, the gNB 204 may transmit a random access response 208. The UE 202 may then transmit a scheduled message 210 using resources granted in the response. The procedure may conclude with a contention resolution message 212. If contention resolution is unsuccessful, the UE 202 may return to the preamble transmission phase.

FIG. 3 illustrates an example of a CBRA procedure 300 using a two-step RA type in accordance with aspects of the present disclosure. A UE 302 may transmit a combined random access preamble 306 and payload 308 to a gNB 304. If contention resolution 310 is successful, the procedure may be considered complete. Otherwise, if the UE 302 receives a fallback indication in a subsequent message, the UE 302 may transmit an additional message and monitor for contention resolution, as discussed in relation to fallback procedures.

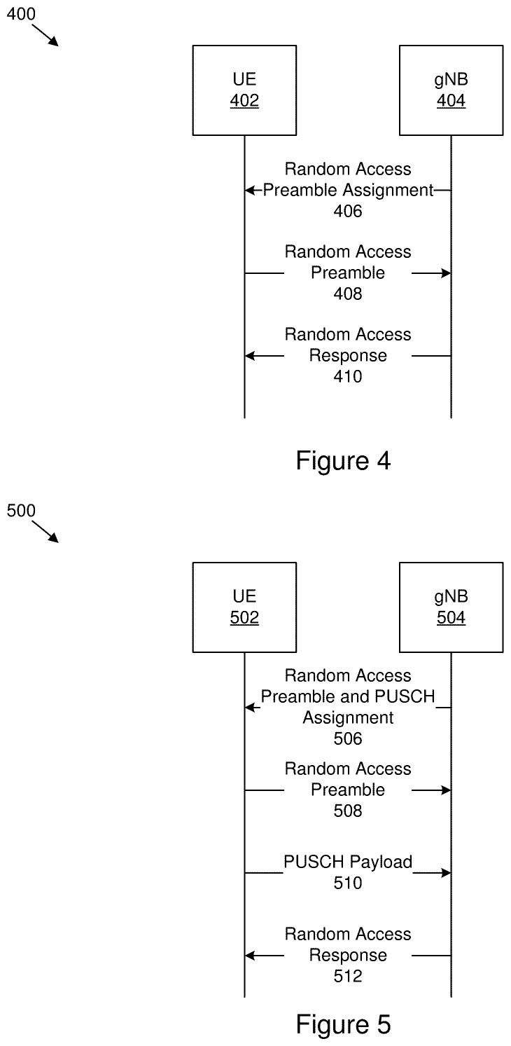

FIG. 4 illustrates an example of a CFRA procedure 400 using a four-step RA type in accordance with aspects of the present disclosure. A gNB 404 may assign a random access preamble 406 to a UE 402. The UE 402 may transmit the assigned preamble 408 to the gNB 404, which may respond with a random access response 410. The procedure may complete without requiring contention resolution.

FIG. 5 illustrates an example of a CFRA procedure 500 using a two-step RA type in accordance with aspects of the present disclosure. A gNB 504 may transmit a preamble and PUSCH assignment 506 to a UE 502. The UE 502 may then transmit a random access preamble 508 and a payload 510. A random access response 512 may be transmitted by the gNB 504, concluding the procedure.

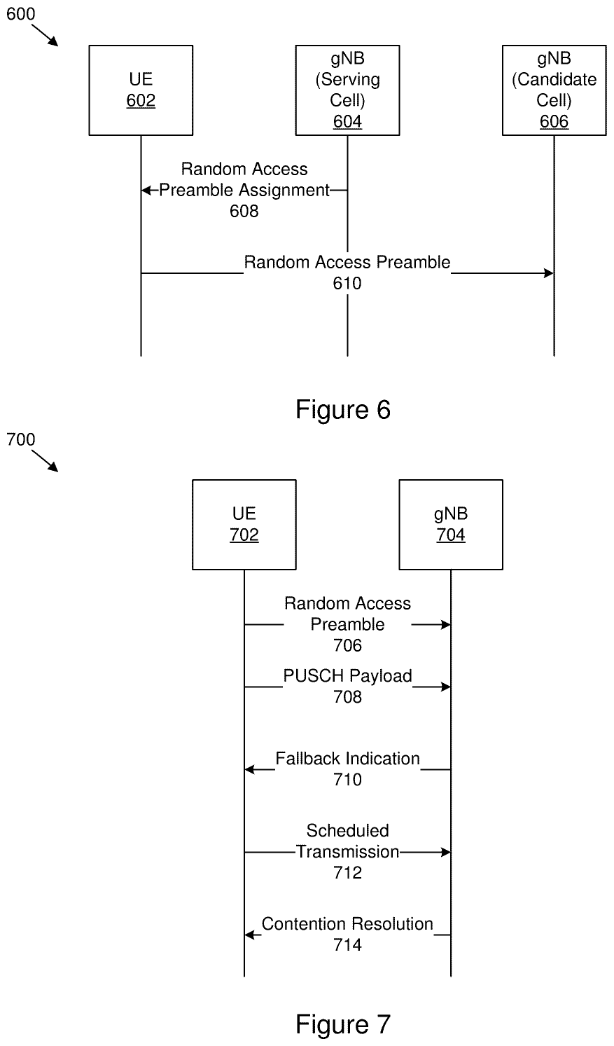

FIG. 6 illustrates an example of a CFRA procedure 600 using a four-step RA type without monitoring for a response from the network. This configuration may apply to early uplink timing acquisition targeting a long-term measurement candidate cell. A gNB 604 may assign a preamble 608 to a UE 602, which may transmit the preamble 610 toward a gNB 606 serving as the candidate cell. The UE 602 may not monitor for a response but may perform one or more retransmissions as directed by the network.

FIG. 7 illustrates additional aspects of RA procedures 700, including fallback and contention resolution. A UE 702 may transmit a preamble 706 to a gNB 704. A fallback indication 710 may be received, prompting the UE 702 to transmit a payload 708 using a scheduled transmission 712. The procedure may conclude with contention resolution 714.

For random access in a cell configured with supplementary uplink (SUL), the network may explicitly signal which carrier—UL or SUL—is to be used. Otherwise, the UE selects the SUL carrier only if the measured DL quality is lower than a broadcast threshold. The UE performs carrier selection before selecting between the two-step and four-step RA types. The reference signal received power (RSRP) threshold for selecting between the RA types may be separately configured for UL and SUL. Once the procedure begins, all uplink transmissions associated with the RA remain on the selected carrier.

The network may associate a set of RACH resources with one or more features applicable to an RA procedure, such as network slicing, reduced capability (RedCap) devices, small data transmission (SDT), or coverage enhancement. A set of RACH resources associated with a specific feature is only valid for RA procedures that involve that feature. Similarly, a set associated with multiple features is valid only for RA procedures involving all of those features. The UE selects the applicable set(s) of RACH resources after uplink carrier (e.g., NUL or SUL) and BWP selection, but before selecting the RA type.

When carrier aggregation (CA) is configured, an RA procedure using the two-step RA type is performed only on the primary cell (PCell), while contention resolution may be cross-scheduled by the PCell.

When CA is configured, for an RA procedure using the four-step RA type, the first three steps of CBRA always occur on the PCell, while contention resolution (step four) may be cross-scheduled by the PCell. For CFRA initiated on the PCell, all three steps remain on the PCell. CFRA on a secondary cell (SCell) may only be initiated by the gNB to establish timing advance for a secondary timing advance group (TAG). In such a case, the procedure begins with a physical downlink control channel (PDCCH) order (step zero) transmitted on an activated SCell of the secondary TAG, followed by preamble transmission (step one) on the SCell and reception of a random access response (step two) on the PCell.

When two TAG identifiers are configured for the serving cell, the TAG to which a timing advance (TA) command applies is indicated in the random access response or in MsgB. To establish timing advance for the other primary TAG, CFRA may be initiated by the gNB using a PDCCH order.

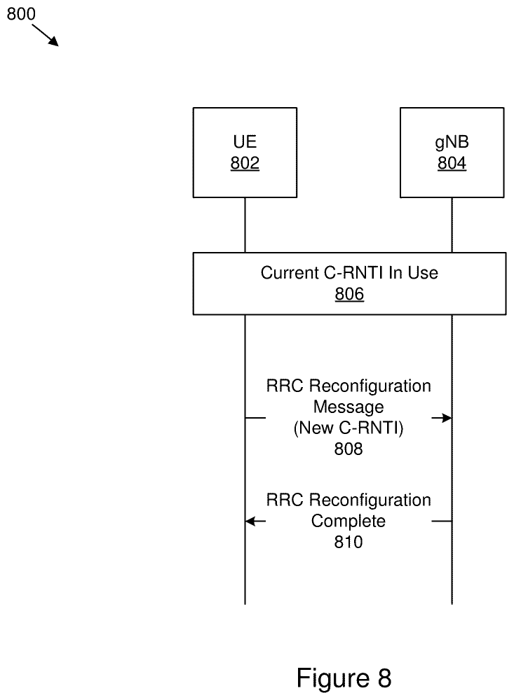

In one embodiment, a new RRC procedure enables the network to signal a new temporary cell-specific UE identifier to the UE while in RRC_CONNECTED. As shown in FIG. 8, the RAN node (e.g., a 5G gNB or analogous 6G node) transmits a security-protected RRC reconfiguration message to the UE. Upon receipt, the UE applies the new identifier as its C-RNTI. If access stratum security has not yet been activated, the UE disregards the RRC reconfiguration.

FIG. 8 illustrates an example of a fallback procedure 800 for CBRA using a two-step RA type in accordance with aspects of the present disclosure. A UE 802 may operate using a temporary ID, such as a C-RNTI 806. A gNB 804 may transmit an RRC reconfiguration message 808 (time T0) to assign a new C-RNTI, and the UE 802 may confirm receipt with an RRC reconfiguration complete message 810 (time T1).

The identity change procedure begins at time T0 and concludes at time T1. The time T1 should occur no later than the expiration of a timer (referred to herein as the “new-timer”) initiated upon transmission of the RRC reconfiguration message containing the new identity by the RAN node (e.g., a gNB in 5G; in 6G, this may correspond to a differently named node). If the new-timer expires without confirmation of identity application, the network may re-initiate the RRC procedure. The new-timer is canceled or released once the network confirms that the UE 802 has successfully applied the new identity.

The new identity may be used immediately for specific functions without requiring any PDCP re-establishment, RLC re-establishment, or MAC reset. One such function includes DCI scrambling.

The payload of downlink control information (DCI) transmitted over the physical downlink control channel (PDCCH) is cyclic redundancy check (CRC) masked using the UE's 802 C-RNTI. Because the network does not know whether the UE 802 has successfully applied the new identity until it receives an RRC reconfiguration complete message, it may continue to transmit DCI scrambled using the current C-RNTI during the transition period from T0 to T1 (as shown in FIG. 8).

If the network does not receive the RRC reconfiguration complete message containing the same RRC transaction identifier used in the RRC reconfiguration message before the new-timer expires, it may restart the identity change procedure. It should be noted that the RRC reconfiguration message and the RRC reconfiguration complete message may have a same transaction identifier.

In one implementation, the RRC reconfiguration message may include a new PUCCH resource associated with the new identity. When the UE 802 transmits downlink hybrid automatic repeat request (HARQ) feedback using this PUCCH, the gNB 804 may infer that the new identity has been applied. Based on the configured behavior, either the current or the new PUCCH resource may then be released. Alternatively, the new PUCCH resource may be preconfigured and only activated upon reception of the RRC reconfiguration message, eliminating the need to include it in that message explicitly.

In some implementations, the network may begin scheduling the UE 802 using the new C-RNTI (e.g., one or more resources for the UE may be scheduled exclusively based on a second temporary ID). For example, the network may provide an uplink grant based at least in part on the second temporary identifier and transmit the uplink grant to the UE. The uplink grant may be used based on a HARQ identifier, or a new data indicator (NDI), or both. In the uplink, if the DCI is scrambled using the new identity (referred to as “new DCI” in Table 1), successful or unsuccessful physical uplink shared channel (PUSCH) reception may still allow the gNB 804 to infer that the UE 802 has adopted the new identity—provided the UE 802 monitors the new DCI and transmits on the granted PUSCH. However, in the absence of PUSCH reception, the gNB 804 may revert to using the old DCI to grant uplink resources. The gNB 804 may optionally attempt to schedule PUSCH using the new DCI for a few repetitions before switching to the old DCI.

In the DL, the gNB 804 may infer that the UE 802 has applied the new identity upon reception of HARQ feedback on the new PUCCH. The gNB 804 may transmit a downlink assignment based at least in part on either the first or second temporary identifier depending on which identity the UE is currently using. Such uplink feedback may be used by the network to determine that the UE has switched to and is actively using the second temporary identifier (e.g., active usage of the second temporary identifier). However, if the PUCCH resource associated with the current identity experiences discontinuous transmission (DTX), the gNB 804 cannot discern whether the DCI was missed or the new identity was not applied. In such cases, the gNB 804 may conservatively send DCI scrambled with the current identity to ensure downlink data delivery. As in the uplink case, the gNB 804 may attempt several transmissions using the new DCI before reverting to the old DCI.

Alternatively, or in combination, the gNB 804 may transmit DCI using both the current and new C-RNTI, targeting the same physical PUSCH resources. Because the UE 802 monitors DCI scrambled only with the identity it currently applies, the risk of resource duplication is avoided. If the UE 802 has not yet applied the new identity, it will ignore the new DCI and respond only to the current identity; once the new identity is applied, the UE 802 will ignore the old DCI.

In the DL, the UE 802 will monitor and decode only the PDCCH scrambled with the new identity once the identity change has taken effect—even if DCI associated with both the current and new identities is received.

From the UE's 802 perspective, different behaviors may be followed in response to the network strategies described above.

In one example, the UE 802 may continue using the current identity until successful delivery of the RRC reconfiguration complete message is confirmed, e.g., via Layer 2 (L2) acknowledgment (ACK). Upon confirmation, the UE 802 applies the new identity and ceases to monitor DCI scrambled using the previous identity, thereby switching entirely to the new identity.

After the UE 802 has applied the new C-RNTI, it may attempt to receive DCI scrambled with both the current (i.e., old) and the new C-RNTI. This dual monitoring may continue until the UE 802 successfully receives DCI scrambled with the new C-RNTI. If a PUCCH configuration is separately associated with the new identity, the UE 802 may use the corresponding PUCCH resource to transmit uplink control information (e.g., ACK/NACK, CSI reports, etc.) upon receiving DCI scrambled with the new C-RNTI. Once the UE 802 applies the new C-RNTI, it may cease monitoring DCI scrambled with the old C-RNTI.

TABLE 1
Network Strategies for Detecting UE Identity Change

| | UL Grant | DL Scheduling |
|---|---|---|
| Old DCI | The gNB may not detect that the | A new PUCCH resource may |
| (scrambled | UE has applied the new identity | be configured to help the gNB |
| with | even if the UE transmits PUSCH | determine whether the UE has |
| current UE | successfully, until T1. | applied the new identity. This |
| identity) | | configuration may be |
| | | temporary (used solely for this |
| | | purpose) or long-term |
| | | (replacing the current PUCCH |
| | | configuration). |
| New DCI | The gNB may determine that the | Upon PUCCH reception, the |
| (scrambled | UE has applied the new identity | gNB may confirm the UE has |
| with new | upon PUSCH reception, regardless | applied the new identity if an |
| UE | of decoding success, if the UE | ACK or NACK is received. If |
| identity) | monitors the new DCI and | DTX occurs on the current |
| | transmits PUSCH. If PUSCH is not | PUCCH resources, the gNB |
| | received, the gNB may revert to | may not know whether the DCI |
| | scheduling using the old DCI until | was missed or the UE failed to |
| | T1. The gNB may also attempt a | apply the new identity. In this |
| | few New DCI-based PDSCH | case, Old DCI may be used to |
| | transmissions before switching | ensure reception reliability. |
| | back to the Old DCI. | The gNB may repeat New |
| | | DCI-based PUSCH |
| | | transmissions several times |
| | | before reverting to Old DCI. |

UEs 802 monitor UE-specific search spaces (SS) on the PDCCH using their C-RNTI. A similar mechanism may be used for identifying old and new search spaces during the identity transition. Multiple UE-specific SS may be configured, and different DCI formats may correspond to different SS. The network may assign different RNTIs (e.g., old and new C-RNTIs) to distinct DCI formats and SS.

In another embodiment, UL and DL retransmissions are addressed in scenarios where the UE 802 identity is changed during the RRC Connected state. For instance, if the identity is changed after an initial uplink transmission but the UE 802 is uncertain whether the gNB 804 successfully received it, the gNB 804 may transmit a retransmission grant using the new C-RNTI. The DCI payload, CRC-masked with the new identity, is treated as valid by the UE 802, and the UE 802 retransmits accordingly.

In the DL, if the temporary cell-specific UE identity of an RRC Connected UE 802 is changed after an initial DL reception attempt but decoding at the UE 802 side was unsuccessful, the UE 802 may: transmit feedback using a separately configured PUCCH for the new identity, if available; or use the currently configured (old) PUCCH for feedback. In such cases, the UE 802 may continue monitoring retransmissions using the current identity.

If HARQ processes are managed independently during the identity transition, the UE 802 might monitor old and new identities for different processes. To prevent this complexity, once the UE 802 identifies a DCI scrambled with the new identity, it may adopt that identity for all HARQ processes. Similarly, in DL, once the UE 802 transmits HARQ feedback via a PUCCH configured for the new identity, it adopts the new identity for all HARQ processes and stops monitoring DCI scrambled with the old C-RNTI. Alternatively, upon receiving a L2 ACK for a RRC Reconfiguration Complete message, the UE 802 may adopt the new identity for all HARQ processes, regardless of the HARQ status.

In one embodiment, a new UL reference signal may be used to indicate to the network that the UE 802 has applied the new identity. This UL reference signal may be configured in the RRC Reconfiguration message (e.g., FIG. 8) or preconfigured using RRC signaling and activated upon RRC Reconfiguration transmission. Alternatively or additionally, a dedicated PUCCH resource may be used to transmit information indicating application of the second temporary identifier.

In another embodiment, temporary cell-specific UE identity is used for RRC Connection Resume. A UE in an RRC Inactive state that initiates a Resume Request during an ongoing identity transition (i.e., until T1) may use the following procedure.

The Resume Request includes a security token, resumeMAC-I (as defined in 5G NR), computed as follows: 1>set resumeMAC-I to the 16 least significant bits of a MAC-I calculated: 2>over ASN.1 encoded VarResumeMAC-Input; 2>with the KRRCint key in the UE Inactive AS Context and the previously configured integrity protection algorithm; and 2>with all input bits for COUNT, BEARER, and DIRECTION set to binary ones.

The UE variable VarResumeMAC-Input specifies the input used to generate the resumeMAC-I during RRC Connection Resume procedure. VarResumeMAC-Input is defined as: VarResumeMAC-Input::=SEQUENCE{sourcePhysCellId PhysCellId, targetCellIdentity CellIdentity, source-c-RNTI RNTI-Value}.

The target cell identity may be set to the cell identity of the first PLMN-Identity in the PLMN-IdentityInfoList broadcast in SIB1 of the target cell. The source physical cell ID is the identity of the PCell the UE 802 was connected to prior to RRC suspension. The source-c-RNTI may be either the old or the newly transmitted C-RNTI. If a new C-RNTI was transmitted, the RAN node may compute resumeMAC-I based on it and share this value with neighbor cells, anchor gNBs, or store it locally.

In one embodiment, temporary cell-specific UE identity is applied to RRC Connection Reestablishment. When reestablishing a connection after a radio link failure or sync reconfiguration failure, the UE 802 may: 1>set the ue-Identity as follows: 2>set the C-RNTI to the current C-RNTI used in the source PCell (reconfiguration with sync or mobility from NR failure) or used in the PCell in which the trigger for the re-establishment occurred; alternatively, it may use a new C-RNTI if received recently and the UE 802 is still in transition phase; 2>set physCellId to the physical cell identity of the source PCell (reconfiguration with sync or mobility from NR failure) or of the PCell in which the trigger for the re-establishment occurred; 2>set shortMAC-I to the 16 least significant bits of a MAC-I calculated: 3>over ASN.1 encoded VarShortMAC-Input; 3>with the KRRCint key and integrity protection algorithm of the source PCell (reconfiguration with sync or mobility from NR failure) or of the PCell in which the trigger for the re-establishment occurred; and 3>with all input bits for COUNT, BEARER, and DIRECTION set to binary ones.

The UE 802 variable VarShortMAC-Input specifies the input used to generate the shortMAC-I during RRC Connection Reestablishment procedure. VarShortMAC-Input is defined as: VarShortMAC-Input::=SEQUENCE{sourcePhysCellId PhysCellId, targetCellIdentity CellIdentity, source-c-RNTI RNTI-Value}.

The target Cell Identity may be an input variable used to calculate the shortMAC-I. The UE 802 may set it to the cell Identity of the first PLMN-Identity in the PLMN-IdentityInfoList broadcasted in SIB1 of the target cell i.e. the cell the UE 802 is trying to reestablish the connection. The sourcePhysCellId may be set to the physical cell identity of the PCell the UE 802 was connected to prior to the reestablishment. In one variation, the source-c-RNTI may be set to current (old) C-RNTI that the UE 802 had in the PCell it was connected to prior to suspension of the RRC connection. In another variation the source-c-RNTI may be set to new C-RNTI that the UE 802 received from the PCell it was connected to prior to suspension of the RRC connection. Upon transmitting the new C-RNTI to the UE 802 (or just before), the serving RAN node may prepare shortMAC-I based on the new C-RNTI and distribute it to each neighboring cell, token prepared with corresponding target cell identity, to let the UE 802 reestablish its RRC Connection.

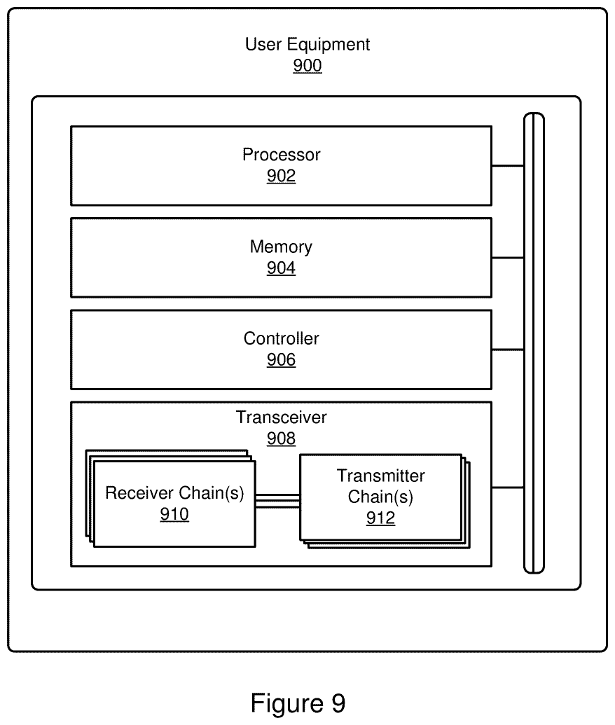

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, a field programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. For example, the processor 902 coupled with the memory 904 may be configured to cause the UE 900 to: transmit a first random access transmission to a base station; receive, in response, a second random access transmission comprising a first temporary identifier; perform a first security procedure with the base station using the first temporary identifier for scheduling; and receive a RRC reconfiguration message that includes a second temporary identifier and initiates a second security procedure. The first security procedure may be performed by transmitting a security mode command message. The security mode command message may direct a UE to enter and or use a security mode.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receive the signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

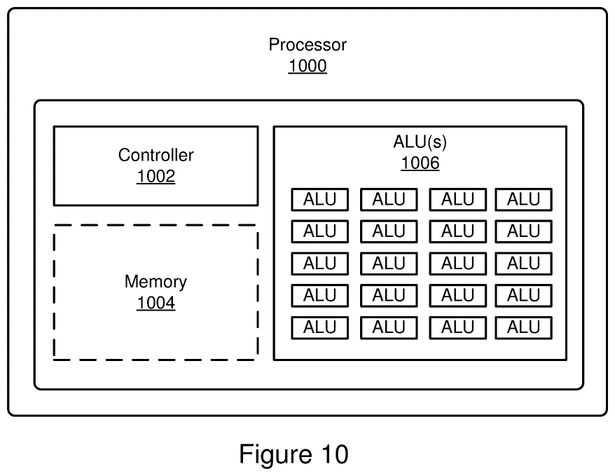

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support a means for performing various operations described herein. For example, the processor 1000 may be configured to: transmit a first random access transmission to a base station; receive, in response, a second random access transmission comprising a first temporary identifier; perform a first security procedure with the base station, wherein the first temporary identifier is for scheduling; and receive a RRC reconfiguration message that includes a second temporary identifier and initiates a second security procedure.

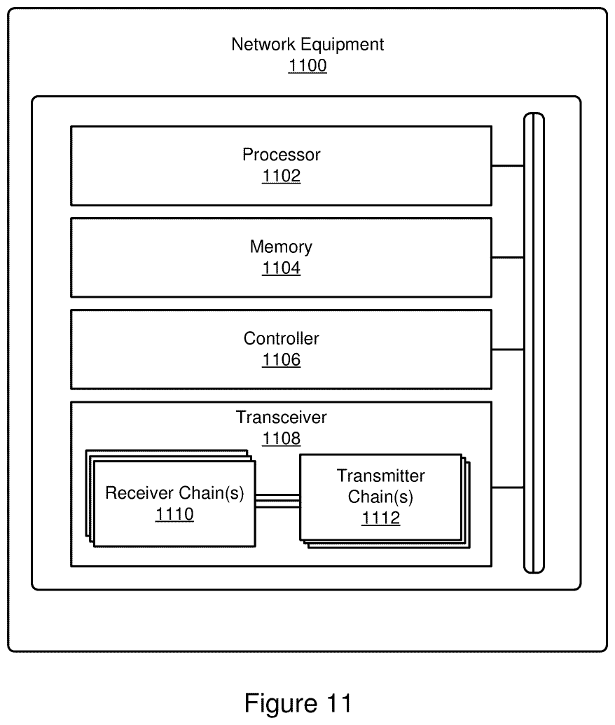

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure. For example, the processor 1102 coupled with the memory 1104 may be configured to cause the NE 1100 to: receive a first random access transmission from a user equipment (UE); transmit a second random access transmission comprising a first temporary identifier to the UE in response; initiate a first security procedure with the UE, wherein the first temporary identifier is for scheduling; and transmit a RRC reconfiguration message that initiates a second security procedure, the RRC reconfiguration message including a second temporary identifier.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

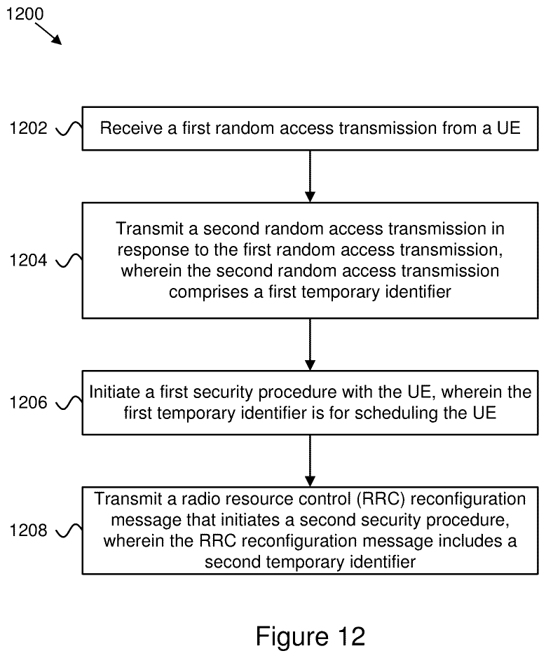

FIG. 12 illustrates a flowchart of a method 1200 in accordance with aspects of the present disclosure. The operations of the method 1200 may be implemented by an NE. In some implementations, the NE may execute a set of instructions to control the function elements of a processor to perform the described functions. It should be noted that the method described herein describes a possible implementation, and that the operations and the steps may be rearranged or otherwise modified and that other implementations are possible.

At 1202, the method may include receiving a first random access transmission from a UE. The operations of 1202 may be performed in accordance with examples as described herein. In some implementations, aspects of the operations of 1202 may be performed by an NE as described with reference to FIG. 11.

At 1204, the method may include transmitting a second random access transmission in response to the first random access transmission, wherein the second random access transmission comprises a first temporary identifier. The operations of 1204 may be performed in accordance with examples as described herein. In some implementations, aspects of the operations of 1204 may be performed by an NE as described with reference to FIG. 11.

At 1206, the method may include initiating a first security procedure with the UE, wherein the first temporary identifier is for scheduling (e.g., scheduling resources) the UE. The operations of 1206 may be performed in accordance with examples as described herein. The operations of 1206 may be performed in accordance with examples as described herein. In some implementations, aspects of the operations of 1206 may be performed by an NE as described with reference to FIG. 11.

At 1208, the method may include transmitting a RRC reconfiguration message that initiates a second security procedure, wherein the RRC reconfiguration message includes a second temporary identifier. The operations of 1208 may be performed in accordance with examples as described herein. In some implementations, aspects of the operations of 1208 may be performed by an NE as described with reference to FIG. 11.

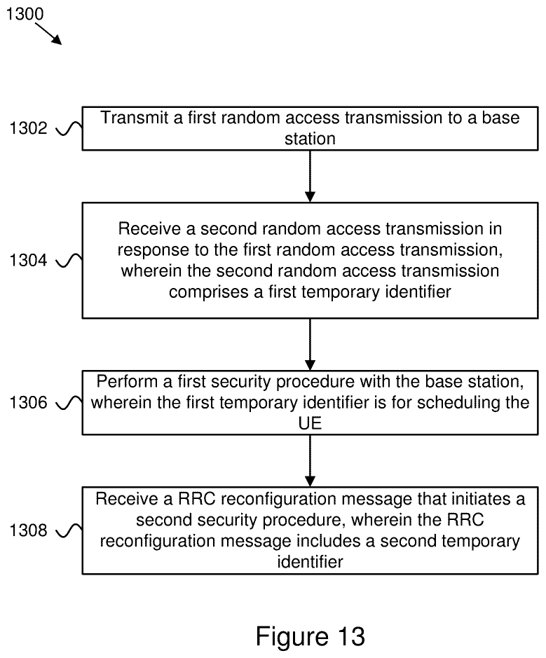

FIG. 13 illustrates a flowchart of a method 1300 in accordance with aspects of the present disclosure. The operations of the method 1300 may be implemented by a UE as described herein. In some implementations, the UE may execute a set of instructions to control the function elements of a processor to perform the described functions. It should be noted that the method described herein describes a possible implementation, and that the operations and the steps may be rearranged or otherwise modified and that other implementations are possible.

At 1302, the method may include transmitting a first random access transmission to a base station. The operations of 1302 may be performed in accordance with examples as described herein. In some implementations, aspects of the operations of 1302 may be performed by a UE as described with reference to FIG. 9.

At 1304, the method may include receiving a second random access transmission in response to the first random access transmission, wherein the second random access transmission comprises a first temporary identifier. The operations of 1304 may be performed in accordance with examples as described herein. In some implementations, aspects of the operations of 1304 may be performed by a UE as described with reference to FIG. 9.

At 1306, the method may include performing a first security procedure with the base station, wherein the first temporary identifier is used for scheduling the UE. The operations of 1306 may be performed in accordance with examples as described herein. In some implementations, aspects of the operations of 1306 may be performed by a UE as described with reference to FIG. 9.

At 1308, the method may include receiving a RRC reconfiguration message that initiates a second security procedure, wherein the RRC reconfiguration message includes a second temporary identifier. The operations of 1308 may be performed in accordance with examples as described herein. In some implementations, aspects of the operations of 1308 may be performed by a UE as described with reference to FIG. 9.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station, comprising:
at least one memory; and
at least one processor coupled with the at least one memory and configured to cause the base station to:
receive a first random access transmission from a user equipment (UE);
transmit a second random access transmission in response to the first random access transmission, wherein the second random access transmission comprises a first temporary identifier;
initiate a first security procedure with the UE, wherein the first temporary identifier is for scheduling the UE; and
transmit a radio resource control (RRC) reconfiguration message that initiates a second security procedure, wherein the RRC reconfiguration message includes a second temporary identifier.

2. The base station of claim 1, wherein the first random access transmission comprises a random access message one (Msg1) of a random access procedure, and wherein the second random access transmission comprises a random access message two (Msg2) of the random access procedure.

3. The base station of claim 1, wherein the first security procedure comprises transmitting a security mode command message, and the at least one processor is configured to cause the base station to:
establish a security context with the UE, wherein the security mode command message is initiated to establish security context.

4. The base station of claim 1, wherein the at least one processor is configured to cause the base station to transmit the RRC reconfiguration message with a physical uplink control channel (PUCCH) resource configuration.

5. The base station of claim 4, wherein the RRC reconfiguration message and a RRC reconfiguration complete message have a same transaction identifier.

6. The base station of claim 1, wherein the at least one processor is configured to cause the base station to:
provide an uplink grant based at least in part on the second temporary identifier; and
transmit the uplink grant to the UE.

7. The base station of claim 1, wherein the at least one processor is configured to cause the base station to transmit a downlink assignment based at least in part on the first temporary identifier or the second temporary identifier.

8. The base station of claim 1, wherein the at least one processor is configured to cause the base station to receive uplink feedback based on an uplink feedback configuration, wherein the received uplink feedback is indicative of an active usage of the second temporary identifier by the UE.

9. The base station of claim 1, wherein the at least one processor is configured to cause the base station to schedule one or more resources for the UE based at least in part on exclusively the second temporary identifier.

10. The base station of claim 1, wherein the at least one processor is configured to cause the base station to, in response to receiving an uplink transmission from the UE, determine that the UE has switched to the second temporary identifier.

11. The base station of claim 1, wherein the at least one processor is configured to cause the base station to, in response to receiving a feedback transmission for a downlink transmission on an uplink feedback resource, determine that the UE has switched to the second temporary identifier.

12. The base station of claim 1, wherein the at least one processor is configured to cause the base station to use the second temporary identifier for RRC connection resumption or reestablishment.

13. The base station of claim 1, wherein the at least one processor is configured to cause the base station to start a timer in response to initiating the second security procedure with the UE, wherein, in response to the timer expiring, the base station reinitiates the second security procedure, and, in response to receiving an acknowledgment from the UE that the second temporary identifier is applied by the UE, the timer is stopped or released.

14. The base station of claim 1, wherein the at least one processor is configured to cause the base station to transmit information on a physical uplink control channel (PUCCH) resource or an uplink (UL) reference signal, wherein the information indicates that the UE has applied the second temporary identifier.

15. A user equipment (UE), comprising:
at least one memory; and
at least one processor coupled with the at least one memory and configured to cause the UE to:
transmit a first random access transmission to a base station;
receive a second random access transmission in response to the first random access transmission, wherein the second random access transmission comprises a first temporary identifier;
perform a first security procedure with the base station, wherein the first temporary identifier is for scheduling the UE; and
receive a radio resource control (RRC) reconfiguration message that initiates a second security procedure, wherein the RRC reconfiguration message includes a second temporary identifier.

16. The UE of claim 15, wherein the at least one processor is configured to cause the UE to monitor downlink control information (DCI) using the second temporary identifier and receive an uplink grant associated with the second temporary identifier.

17. The UE of claim 16, wherein the uplink grant is used based on a hybrid automatic repeat request (HARQ) identifier, or a new data indicator (NDI) status, or both.

18. The UE of claim 15, wherein the at least one processor is configured to cause the UE to transmit uplink feedback based on an uplink feedback configuration associated with the second temporary identifier.

19. A method performed by a base station, the method comprising:
receiving a first random access transmission from a user equipment (UE);
transmitting a second random access transmission in response to the first random access transmission, wherein the second random access transmission comprises a first temporary identifier;
initiating a first security procedure with the UE, wherein the first temporary identifier is for scheduling the UE; and
transmitting a radio resource control (RRC) reconfiguration message that initiates a second security procedure, wherein the RRC reconfiguration message includes a second temporary identifier.

20. A method performed by a user equipment (UE), the method comprising:
transmitting a first random access transmission to a base station;
receiving a second random access transmission in response to the first random access transmission, wherein the second random access transmission comprises a first temporary identifier;
performing a first security procedure with the base station, wherein the first temporary identifier is for scheduling the UE; and
receiving a radio resource control (RRC) reconfiguration message that initiates a second security procedure, wherein the RRC reconfiguration message includes a second temporary identifier.
